(19) United States
(12) Patent Application Publication
(10) Pub. No.: US 2023/0131294 A1
(43) Pub. Date: Apr. 27, 2023

(54) EXECUTABLE CODE BLOCKS BASED ON CAPTURED USER INTERACTIONS

(71) Applicant: CLEAR CONTRACTS INC., Wildwood, MO (US)

(72) Inventors: Logan PANCHOT, Washington, DC (US); Justin SCHREINER, Denver, CO (US)

(73) Assignee: CLEAR CONTRACTS INC., Wildwood, MO (US)

(21) Appl. No.: 17/510,965

(22) Filed: Oct. 26, 2021

(51) Int. Cl. G06Q 20/40; G06F 16/23

(52) U.S. Cl. CPC G06Q 20/401; G06F 16/2365; G06Q 2220/00

(57) ABSTRACT

A first contract generation interface may be provided on a first user device, and, through the first contract generation interface, a first user may select a contract type and enter contract formation values (e.g., payment associated with the contract). A template may be retrieved based on the selected contract type and the retrieved template may be populated using the contract formation values. A second contract generation interface may be provided on a second user device for a second user to accept or modify the entries from the first user. Should there be disagreements between the first and second users, a third contract generation interface may be provided to a third user device for a third user to arbitrate the contract formation between the first user and the second user. An executable coded block may be generated based on the captured interactions (e.g., using the templates) and deployed on the blockchain.

### TECHNICAL FIELD

This disclosure relates to generating and deploying executable code blocks (e.g., smart contracts) in a blockchain, particularly to capturing interactions between users through contract generation interfaces and generating executable code blocks based on the captured interactions.

### BACKGROUND

Blockchains have been increasingly used to maintain data integrity based on distributed ledger technology. Copies of a distributed ledger may be stored by multiple nodes in the blockchain, and the multiple nodes attempt to update the corresponding stored copies with new blocks, as the new blocks are generated. Because multiple nodes may maintain the same ledger and update the ledger using the same new blocks, the integrity check of the data stored in the blockchain may be through polling of the multiple nodes. If such polling indicates that a threshold number of nodes have the same copy of the distributed ledger (or the same chain of blocks), the integrity of the distributed ledger may not have been compromised. A smart contract, which may be within an executable code block, is an example of the data that may be stored in a blockchain. Integrity of smart contracts may also be maintained using distributed ledger technology.

### SUMMARY

Conventional executable code block (e.g., smart contract) generation has several technical shortcomings. For instance, conventional systems do not provide a platform for generating an executable code block based on interactions between different contracting and non-contracting users. This disclosure attempts to fulfil this technological gap and may provide other technical benefits as well.

Embodiments disclosed herein may capture interactions between different users, generate an executable code block (e.g., smart contract) based on the captured interactions, and deploy the generated executable code block to a blockchain. For instance, a first contract generation interface may be provided on a first user device, and a first user may, on the first contract generation interface, select a contract (or code block) type and enter contract formation values (e.g., payment associated with the contract). A template may be retrieved based on the selected contract type and the retrieved template may be populated using the contract formation values. A second contract generation interface may be provided on a second user device for a second user to accept or modify the entries from the first user. Should there be disagreements between the first and second users, a third contract generation interface may be provided to a third user device for a third user to arbitrate the contract formation between the first user and the second user. A smart contract may be generated based on the captured interactions (e.g., by using the templates) and deployed on the blockchain.

In an embodiment a computer implemented method of generating and deploying an executable code block to a blockchain is provided. The method may include receiving, from a first interface displayed at a first user device associated with a first user, a selection of a type of code block and a plurality of values associated with the selected code block type; retrieving a template corresponding to the selected code block type; populating the template by executing a code generator on the plurality of values to generate an initial code block; receiving from a second interface displayed at a second user device associated with a second user, one or more responses associated with the initial code block; in response to determining that the one or more responses indicate the initial code block is accepted: generating an executable code block based on the populated template and the one or more responses; and deploying the executable code to a blockchain.

In another embodiment, a system is provided. The system may include a processor and a non-transitory memory storing computer program instructions. The processor may be configured execute the computer program instructions to cause the system to perform operations including receiving, from a first interface displayed at a first user device associated with a first user, a selection of a type of code block and a plurality of values associated with the selected code block type; retrieving a template corresponding to the selected code block type; populating the template by executing a code generator on the plurality of values to generate an initial code block; receiving from a second interface displayed at a second user device associated with a second user, one or more responses associated with the initial code block; in response to determining that the one or more responses indicate the initial code block is accepted: generating an executable code block based on the populated template and the one or more responses; and deploying the executable code block to a blockchain.

This summary merely provides some example embodiments and should not construed as a summary for the entire disclosure.

### BRIEF DESCRIPTION OF THE DRAWINGS

The foregoing and other aspects of embodiments are described in further detail with reference to the accompanying drawings, in which the same elements in different figures are referred to by common reference numerals. The embodiments are illustrated by way of example and should not be construed to limit the present disclosure.

FIG. 1 shows an illustrative network environment for generating and deploying an executable code block on a blockchain, according to an embodiment.

FIG. 2 shows an illustrative architecture of a computing device that may be used for generating and deploying an executable code block on a blockchain, according to an embodiment.

FIG. 3 shows a flow diagram of an illustrative method of generating and deploying an executable code block on a blockchain, according to an embodiment.

FIG. 4 shows a flow diagram of an illustrative method of resolving an active executable code block, according to an embodiment.

FIG. 5 shows an illustrative process of generating an executable code block based on user inputs, according to an embodiment.

### DETAILED DESCRIPTION

Smart contracts may be executable codes (e.g., in the form of executable code blocks) that may be stored in a blockchain. The distributed ledger technology, that may underlie blockchains, may maintain the integrity of the smart contracts without a central authentication entity. Smart contracts are generally developed to govern the relationship between two or more users. However, conventional smart contracts generation technology fails to provide mechanisms to capture interactions between multiple users and generate smart contracts based on the captured interactions.

Embodiments disclosed herein capture interactions between multiple users, generate smart contracts based on the captured interactions, and deploy the generated smart contracts (e.g., as executable code blocks) to a blockchain. To that end, a back-end server may cause user devices of the multiple users to generate contract formation interfaces. For example, the server may transmit instructions for a first client device associated with a first user to generate a first contract formation interface. The first contract formation interface may allow the first user to select a contract type (e.g., an escrow contract) and enter one or more values (e.g., payment amount) associated with the contract. The first contract formation interface therefore may be used for initiating contract formation.

The server may retrieve a template for the selected contract type and populate the retrieved template with the entered contract values. A populated template may therefore be a pending contract (also referred to as an initial code block). The server may cause a second user device associated with a second user to display a second contract formation interface. The second contract formation interface may display the values and terms and conditions of the pending contract (or initial code block) and allow the second user to propose modifications thereto. The server may capture these interactions, which may be for a few cycles as the first and second users interact through the contract formation interfaces in their corresponding devices. If both users agree, then the finalized template may be converted to a smart contract and deployed, as an executable code block, to the blockchain.

If however, the users do not agree, the server may generate a third contract formation interface on a third device associated with a third user. The third user may be an arbitrator. Using the third contract formation interface, the third user may provide inputs to resolve the differences between the users. If the differences are resolved, the corresponding finalized template may be converted to a smart contract and deployed to the blockchain. The interactions between the three users may go through multiple cycles through a series of corresponding contract formation interfaces before finalization. Upon finalization, a smart contract may be automatically generated and deployed on the blockchain as an executable code block.

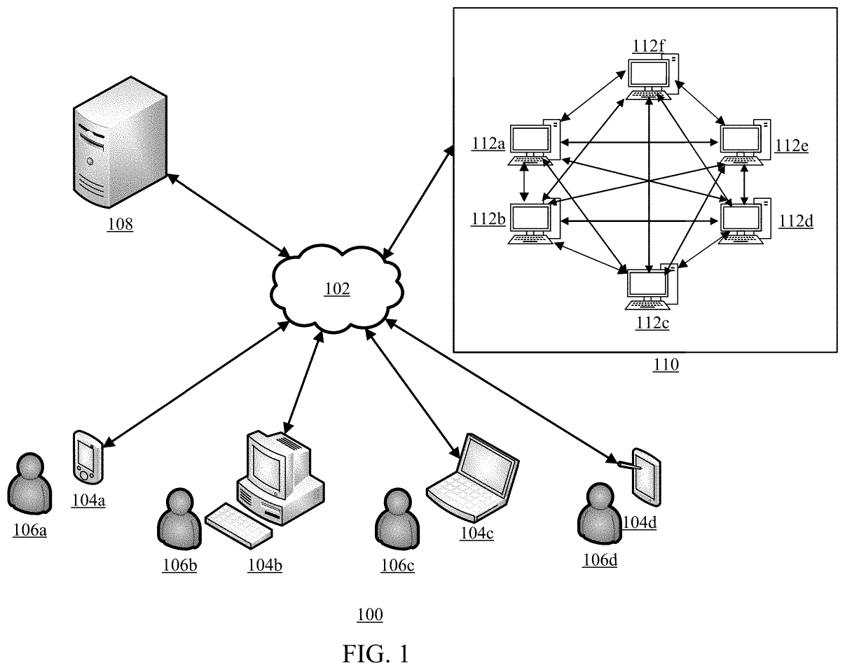

FIG. 1 shows an illustrative network environment 100 for generating and deploying an executable code block (e.g., smart contract) on a blockchain, according to an embodiment. As shown, the network environment 100 may comprise a network 102, user devices 104a-104d (commonly or collectively referred to as 104) associated with users 106a-106d (commonly or collectively referred to as 106), a server 108, and a blockchain comprising nodes 112a-112f (commonly or collectively referred to as 112). It should however be understood that the components shown in FIG. 1 and described herein are just examples, and network environments with additional, alternative, or fewer number of components should also be considered within the scope of this disclosure.

Within the network environment, the network 102 may include any kind of networks configured to facilitate communication between components within the network environment 100. To that end, the network may 102 may comprise wired and wireless communication links that may operate through any type of circuit switching and/or packet switching technology. For example, the network 102 may include local area network (LAN), metropolitan area network (MAN), wide area network (WAN), the Internet, and/or a telephony network.

The user devices 104 may include any kind of computing device that may communicate through the network 102 with other components within the network environment 100. For instance, the user devices 102 may include a mobile phone 104a (which may be a smartphone) being used by a user 106a, a desktop computer 104b being used by a user 106b, a laptop computer 104c being used by a user 106c, and a tablet computer 104d being used by a user 106d. These are just but a few examples of user devices 104 and any kind of computing device should be considered within the scope of this disclosure. Furthermore, although four user devices 104 are shown in FIG. 1 and described herein as examples, network environments including any number of user devices 104 should be considered within the scope of this disclosure.

The server 108 may include a computing device executing a back-end server functionality described throughout this disclosure. The computing devices may be of any kind, including but not limited to, a server computer, a desktop computer, a laptop computer, tablet computer, or a mobile phone. Although shown here as a single component, the server 108 may include any number of components that may be co-located (e.g., in a server farm) or geographically distributed. The server 108 may include databases, e.g., user databases, that may be used for storing data for the functionality described throughout this disclosure.

The blockchain 110 may be any kind of blockchain that may store smart contracts (e.g., as executable code blocks) described throughout this disclosure. Non-limiting examples of the blockchain 110 may include a Bitcoin blockchain, a Ethereum blockchain, or Cardano blockchain. Regardless of the type of blockchain 110, it may include different nodes, e.g., nodes 112a-112f shown in FIG. 1, that may maintain distributed ledgers and use a consensus mechanism (e.g., proof of work or proof of authority) to push updates to the distributed ledgers. The integrity of the data in the distributed ledgers may be based on polling multiple nodes and compare the corresponding copies of distributed ledgers.

In operation, a user 106a may transmit to the server 108 an indication of forming a contract with user 106b. In response, the server 108 may generate an interface (e.g., a form on a browser or an application) on the user device 104a. Through the interface, the user 106a may provide pieces of information for the contract. The pieces of information may include, for example, type of contract (e.g., escrow contract), amount of contract, date on when the contract becomes effective, name of the user 106a, name of the user 106b, and/or any other piece of information for generating the contract. The server 108 may receive the input from the user 106a and retrieve a template associated with the type of contract selected by the user 106a. The server 108 may then execute a code generator to add the values of the contract (e.g., the amount of contract) in the template. After creating the template, the server 108 may transmit the information to the user device 104b to allow the user 106 to observe and modify the contract proposed by the user 106a. The user 106b may provide an indication of acceptance of the contact, in which case the server 108 may generate a smart contract and deploy the same on the blockchain 110 as an executable code block. However, in cases where the user 106a does not provide an indication of an acceptance of the contract, the server 108 may transmit the contract to the user 106c, who may perform the role of an arbitrator. If the user 106c agrees that the contract should formulated, a corresponding smart contract may be generated and deployed to the blockchain 110 as an executable code block.

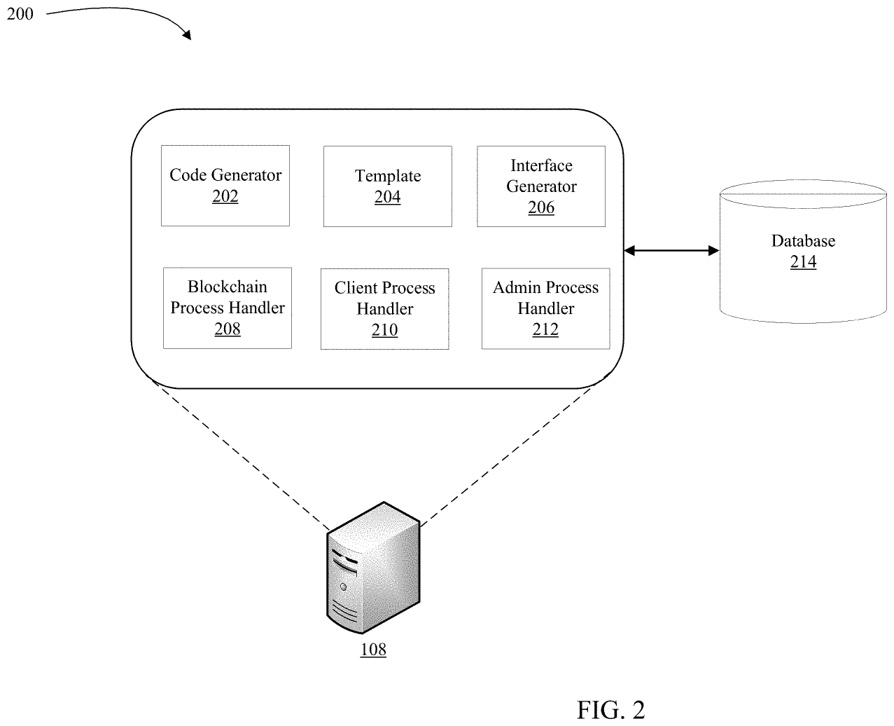

FIG. 2 shows an illustrative architecture 200 of a computing device (e.g., server 108) that may be used for generating and deploying an executable code block (e.g., a smart contract) on a blockchain. As shown the server 108 may include, e.g., within a non-transitory memory, a plurality of functional modules, wherein the modules may include hardware components, software components, or both hardware and software components. As shown, the example modules may include a code generator 202, a template 204, an interface generator 206, a blockchain process handler 208, a client processor handler 210, and an admin process handler 212. The modules may interact with database 214, which may include any kind of storage medium. It should however be understood that the modules shown in FIG. 2 and described herein are just examples and additional, alternative, and fewer number of modules should also be considered within the scope of this disclosure.

The code generator 202 may translate the values received from one or more users to be compatible with the template 204. The user provided values may have a different format than the one desired for the template 204, e.g., the template may use a monetary value having a “$” sign and two decimal points; and the code generator 202 may translate a non-compatible value entered by the user to a compatible form. The code generator 202 may also determine locations for different user entered values for the template 204 and then populate the template in the determined locations.

The template 204 may include any kind of template for generating a smart contract. For example, the template 204 may be for an escrow contract. Multiple templates 204 may be maintained to correspond to the user selected contract type. For instance, while a first template 204 may be for an escrow contract, a second template 204 may be for a real estate contract. The server 108 may receive the user selected contract type and retrieve the appropriate template 204 for further processing.

The interface generator 206 may generate contract formation interfaces for different user devices (e.g., user devices 104a-104d, as shown in FIG. 1). For instance, the interface generator 206 may generate a first contract formation interface on a first user device, a second contract formation interface on a second user device, and a third contract formation interface on a third user device. The contract formation interfaces may be displayed on web-browser or stand-alone applications on the corresponding user devices.

The blockchain process handler 208 may upload and download the data from the blockchain (e.g., blockchain 110, as shown in FIG. 1). The upload may include uploading a generated smart contract, as an executable code block, to the blockchain. The download may include downloading a smart contract from a blockchain for contract resolution.

The client process handler 210 may facilitate the interaction of the sever 108 with different user devices (e.g., user devices 104a-104d, as shown in FIG. 1). For example, the client process handler 210 may receive inputs made by the users in the different user devices. The client process handler 210 may also handle other communications with the client devices (e.g., sending an email alert).

The admin process handler 212 may handle interactions with an administrative user. The administrative user may provide one or more configuration instructions to configure different operations performed by the server 108, and the admin process handler 212 may receive the instructions and accordingly configure the identified operations. The admin process handler 212 may also provide the administrative user with operational details of the system, such as error messages and exceptions to generally assist the administrative user to keep the system running.

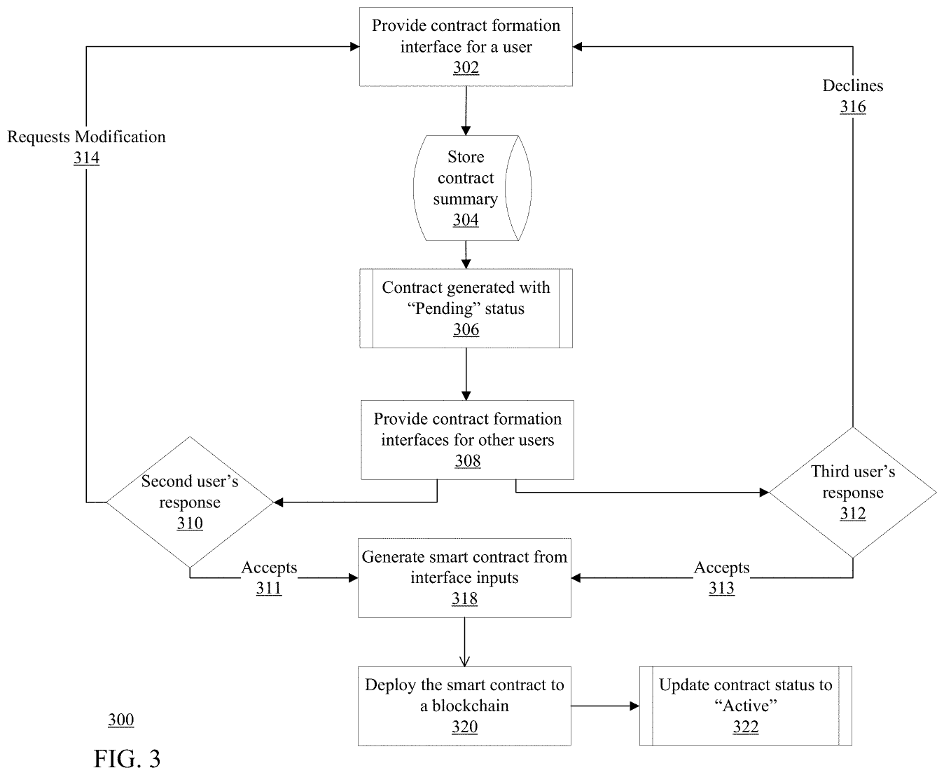

FIG. 3 shows a flow diagram of an illustrative method 300 of generating and deploying an executable code block (e.g., a smart contract) on a blockchain, according to an embodiment. The steps of the method 300 may be executed by any type of computing device (e.g., server 108 in the network environment 100 shown in FIG. 1). Furthermore, it should be understood that the steps of the method 300 are merely provided as examples and methods with additional, alternative, and fewer number of steps should also be considered within the scope of this disclosure. It should also be understood that the steps need not be executed in the sequence shown in FIG. 3.

In step 302, a contract formation interface may be provided to a user. For example, in the network environment shown in FIG. 1, the user may include a first user 106a, and the contract formation interface may be generated by the server 108 and transmitted to a first user device 104a. The contract formation interface, e.g., rendered in the display of the first device 104a, may include a form. The form may allow the user, e.g., the first user 106a, to select a type of contract and a plurality of values associated with the contract. The type of contract (also referred to as contract type or code block type) may include, e.g., an escrow contract, a real estate buy/sell contract, a sports contract, and/or any other type of contract. The plurality of values associated with the selected contract type may include, e.g., amount of escrow fund, purchase price, name of the contracting parties, effective date of the contract, expiration date of the contract, selectable terms and conditions of the contract, and/or any other values associated with contract formation. To provide the input, the user may interact with graphical objects in the contract formation interface. For instance, within the interface, spaces may be provided for the user to enter values (e.g., escrow fund amount), selectable boxes may be provided for the terms and conditions, and/or drop down menus may be provided for the user to indicate agreements/disagreements. Using these graphical objects, the user may provide and values for forming a contract.

In step 304, a contract summary may be stored. For example, in the network environment 100 as shown in FIG. 1, the server 108 may store the contract summary in a database. The contract summary may include the selected contract type (or code block type) and the values received from the user. The stored contracts summary may be used for generating a smart contract (or executable code block) by executing the subsequent steps of the method 300, and/or may be used for generating future smart contracts. Furthermore, the stored contracts summary may be analyzed to determine contract formation patterns, which may then be used for improving the contract formation process and/or for advertisement.

In step 306, a contract may be generated with a “pending” status (or as an initial code block). To generate the contract, a template (e.g., template 204 in the server 108 as, as shown in FIG. 2) may be retrieved. The template retrieval may be based on the selected contract type. For example, an escrow contract may be associated with an escrow template and a real estate contract may be associated with a real estate template. A database (e.g., database 214, as shown in FIG. 2) may store the templates in association with the contract types. The selected contract type may then be used for retrieving a template corresponding to the selected contract type.

When the template is retrieved, a code generator (e.g., a code generator module 202, as shown in FIG. 2) may convert the values received from the user to be compatible with the retrieved template. For instance, if the received values include a monetary amount, the code generator may convert the format of the monetary amount into the format for the template (e.g., with a “$” sign and two decimal places). The code generator may further determine locations, within the template, for different received values. Overall, the code generator may perform operations such that the received values may be used to populate the retrieved template and generate a pending contract (also referred to as an initial code block). The pending contract may be stored in a non-blockchain database (e.g., database 214, as shown in FIG. 2).

In step 308, contract formation interfaces for other users may be provided. The users may include, for example, a second user who may be a counterpart contracting party to the user initiating the contract formation, and/or a third user who may be an arbitrator for forming the contract between the first user and the second user. In the network environment 100 shown in FIG. 1, the second user may be user 106b associated with second device 104b and the third user may be user 106c associated with the third device 104c.

For the second user, the contract formation interface may provide the selections made by the first user (i.e., the user who initiated the contract formation). These selections may be provided as graphical objects, which may allow the second user to accept, reject, or modify the terms and values selected by the first user. For instance, a graphical object in the second device may show a contractual amount (e.g., an escrow amount for an escrow contract), which may be modified (e.g., as a counter offer) by the second user. As another example, the contract formation interface may provide graphical objects, such as drop down menus or radio buttons, for the second user to accept or deny different terms and conditions selected by the first user. As yet another example, the contract formation interface may provide graphical objects for the second user to propose additional terms and conditions for the contract, and/or to propose other modifications. If the second user requests modifications 314, steps 302-310 may be repeated to generate a modified contract. Furthermore, multiple cycles of these steps 302-310 may be repeated until there is an agreement between the first user and the second user. However, if the second user accepts 311 the contract proposed by the first user, step 318 may be executed.

For the third user, the contract formation interface may be generated if an arbitration is required between the first user and the second user. For instance, if there have been multiple modifications of terms between the first user and the second user and/or if there is a disagreement between the first user and the second user, the contract formation for the third user interface may provide graphical objects indicating the points of disagreements. For instance, a graphical object for a contract term may indicate a position of the first user (acceptance) and a contrary position (denial) of the second user. Using the contract formation interface, the third user may agree to the position of either of the first user or the second user. Other graphical objects may be provided for the third user to modify values of the contract (e.g., to select an amount between the first user's proposed amount and the second user's proposed amount). If there is an acceptance 313 by the third user, step 318 may be executed. However, if the third user declines 316 one or more terms or conditions of the contract being negotiated by the first user and the second user, steps 302-312 may be repeated (e.g., to allow for the first user and the second user to continue negotiation and for the third user to arbitrate).

In step 318, which may executed when there is agreement between the first user and the second user or when there is an agreement between all the three users, a smart contract (or executable code block) may be generated based on the interface inputs. The interface inputs (e.g., received from the first user, the second user, and/or the third user) may indicate the final, agreed-upon values for the contract. Furthermore, the interface inputs may indicate the final, agreed-upon terms and conditions of the contract. Using these final, agreed-upon values and/or terms and conditions, the corresponding populated template may be converted into a smart contract code (e.g., to be included in the executable code block). For instance, the natural language syntax of the contract may be codified into one or more of high-level, assembly level, and/or machine level code. The code so generated may be executed on a processing device (e.g., one or more user devices 104 within the network environment 100 shown in FIG. 1).

In step 320, the generated smart contract may be deployed to a blockchain (e.g., blockchain 110 of the network environment 100 shown in FIG. 1) as an executable code block. In one embodiment, the blockchain may include the Cardano blockchain. However, any kind of blockchain should be considered within the scope of this disclosure. The deployment process may use any kind of block formation, e.g., based on proof of work, proof or authority, proof of stake, cooperative block formation, and/or any other kind of block formation algorithm. After the deployment of the smart contract to the blockchain, step 322 may be executed to update the status of the deployed contract to “active.”

The active contract deployed in the blockchain may be resolved at any point in time after deployment. In other words, the contracting parties (e.g., the first user and the second user) and possibly the arbitrator (e.g., the third user) may perform operations for downstream transactions in accordance with the active contract. An example resolution of an active escrow contract is described below.

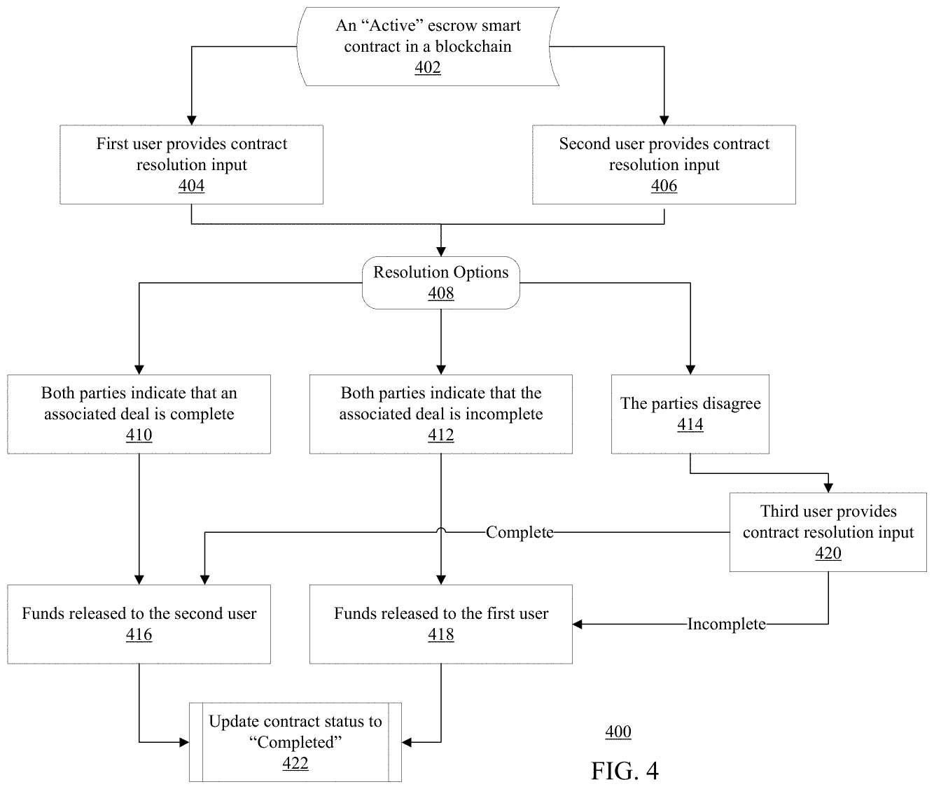

FIG. 4 shows a flow diagram of an illustrative method 400 of resolving an active executable code block (e.g., an active escrow smart contract) on a blockchain, according to an embodiment. The steps of the method 400 may be executed by any type of computing device (e.g., server 108 in the network environment 100 shown in FIG. 1). Furthermore, it should be understood that the steps of the method 400 are merely provided as examples and methods with additional, alternative, and fewer number of steps should also be considered within the scope of this disclosure. It should also be understood that the steps need not be executed in the sequence shown in FIG. 4. Additionally, the escrow smart contract (also referred to as an escrow smart agreement) is merely for illustration, and the method 400 may be used for any kind of smart contract (or executable code block).

In step 402, an active escrow contract in the blockchain may be retrieved. For instance, within the network environment 100 shown in FIG. 1, a first user device 104a associated with a first user 106a may download the smart contract code from the blockchain 110. This download may include additional operations such as authentication of the first user 106a and/or other blockchain operations.

In step 404, the first user (e.g., first user 106a, as shown in FIG. 1) may provide a contract resolution input. The contract resolution input may be provided in an interface in the associated first user device (e.g., user device 104a, as shown in FIG. 1). In the context of the escrow contract, the first user may indicate that an associated deal is complete and that the escrow funds are to be transferred from the first user to a second user (e.g., second user 106b, as shown in FIG. 1). In step 406, the second user may provide a corresponding contract resolution input. The second user may provide the contract resolution input in response to the first user providing the corresponding contract resolution input in step 404. However, it should be understood that any of the first user or the second user may initiate the contract resolution by providing a corresponding resolution input.

In step 408, a determination is made as to the contract resolution options. The resolution options may be based upon the resolution inputs provided by the first user and the second user. If both the first user and the second user indicate that the associated deal is complete 410, step 416 may be executed to release the escrow funds to the second user. If both the first user and the second user indicate that the associated deal is incomplete 412, step 418 may be executed to release the escrow funds to the first user.

However, if there is a disagreement 414 between the first user and the second user, step 420 may be executed to receive a contract resolution input from a third user (e.g., third user 106c using the third user device 104, as shown in FIG. 1). The third user may function as an arbitrator between the first user and the second user. If the third user indicates that the associated deal is complete, step 416 may be executed to release the escrow funds to the second user. Alternatively, if the third user indicates that the associated deal is incomplete, step 418 may be executed to release the escrow funds to the first user.

After the contract has been resolved either by executing step 416 (e.g., for a complete deal) or by executing step 418 (e.g., for an incomplete deal), step 422 may be executed to update the contract status to “completed.” In addition to the updated statues, an associated update block may be uploaded to the blockchain indicating that the corresponding smart contract has been resolved.

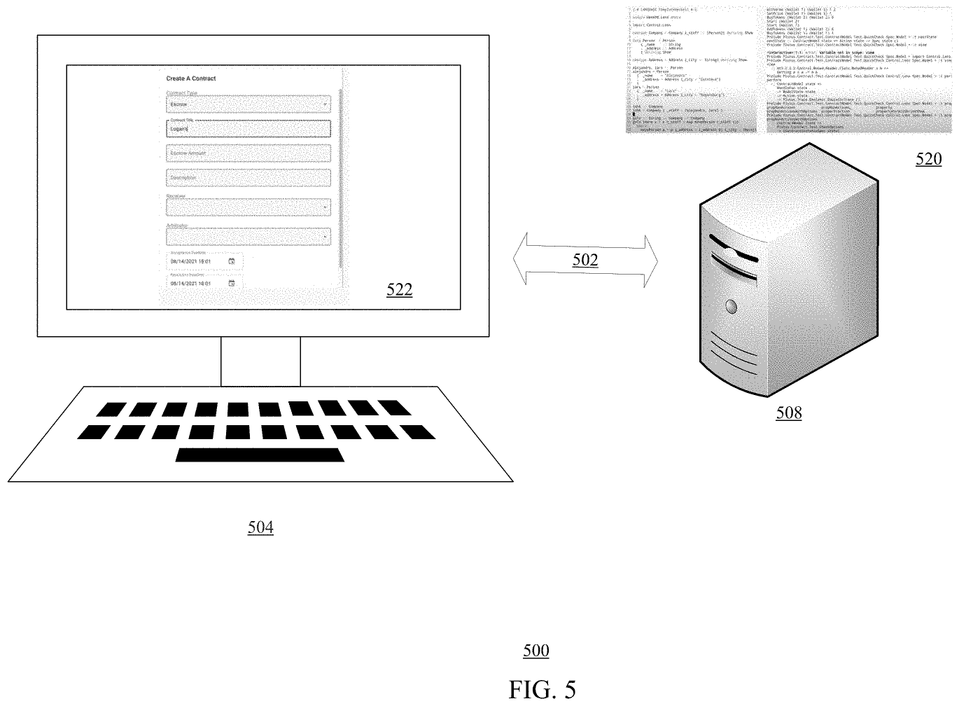

FIG. 5 shows an illustrative process 500 of generating an executable code block (e.g., a smart contract) based on user inputs. For example, a user device 504 may display a contract formation interface 522 based on receiving a communication from a server 508 through a communication channel 502. The contract formation interface 522 may include, for example, a form allowing a corresponding user to select a contract type and also to enter different values (e.g., name of the contracting parties) for generating a smart contract. The server 508 may receive the values entered in the contract formation interface 522 though the communication channel 502. The server 508 may retrieve a template corresponding to the contract type and use a code generator to populate the template. The server 508 may then generate a smart contract 520 from the populated template and deploy the generated contact to a blockchain (e.g., Cardano blockchain).

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A computer-implemented method of generating and deploying an executable code block to a blockchain, comprising:
receiving, from a first interface displayed at a first user device associated with a first user, a selection of a type of code block and a plurality of values associated with the selected code block type;
retrieving a template corresponding to the selected code block type;
populating the template by executing a code generator on the plurality of values to generate an initial code block;
receiving from a second interface displayed at a second user device associated with a second user, one or more responses associated with the initial code block;
in response to determining that the one or more responses indicate the initial code block is accepted:
generating an executable code block based on the populated template and the one or more responses; and
deploying the executable code block to a blockchain.

2. The computer-implemented method of claim 1, further comprising:
in response to determining that the one or more responses indicate a modification to the initial code block:
transmitting a notification to the first user, the notification containing an indication of the modification of the initial code block;
receiving an acceptance of the modification from the first user; and
generating the executable code block based on the populated template and the modification.

3. The computer-implemented method of claim 1, further comprising:
in response to determining that the one or more responses indicate a modification to the initial code block:
transmitting a notification to the first user, the notification containing an indication of the modification of the initial code block;
receiving a denial of the modification from the first user;
providing instructions to generate a third interface on a third user device associated with a third user, the third interface allowing the third user to provide an arbitration response;
receiving the arbitration response; and
generating the executable code block based on the populated template, the modification, and the arbitration response.

4. The computer-implemented method of claim 1, further comprising:
after deploying the executable code block to the blockchain, update a status of the executable code block to active.

5. The computer-implemented method of claim 1, further comprising:
storing a summary of the deployed executable code block to a non-blockchain database.

6. The computer-implemented method of claim 1, wherein the deployed executable code block includes an escrow agreement between the first user and the second user, and wherein the deployed executable code block is associated with an escrow fund. 7 The computer implemented method of claim 6, further comprising:
receiving a first resolution input from the first user;
receiving a second resolution input from the second user; and
in response to determining that the first resolution input and the second resolution input indicate a deal completion between the first user and the second user:
transferring the escrow fund to the second user.

8. The computer-implemented method of claim 6, further comprising:
receiving a first resolution input from the first user;
receiving a second resolution input from the second user; and
in response to determining that the first resolution input and the second resolution input indicate a deal non-completion between the first user and the second user:
transferring the escrow fund to the first user.

9. The computer-implemented method of claim 6, further comprising:
receiving a first resolution input from the first user;
receiving a second resolution input from the second user; and
in response to determining that the first resolution input and the second resolution input indicate a disagreement between the first user and the second user:
requesting a third user to provide a third resolution input; and
in response to determining that the third resolution input indicates a deal completion between the first user and the second user:
transferring the escrow fund to the second user.

10. The computer-implemented method of claim 6, further comprising:
receiving a first resolution input from the first user;
receiving a second resolution input from the second user; and
in response to determining that the first resolution input and the second resolution input indicate a disagreement between the first user and the second user:
requesting a third user to provide a third resolution input; and
in response to determining that the third resolution input indicates a deal non-completion between the first user and the second user:
transferring the escrow fund to the first user.

11. A system comprising:
a processor; and
a non-transitory memory storing computer program instructions, that when executed by the processor cause the system to perform operations comprising:
receiving, from a first interface displayed at a first user device associated with a first user, a selection of a type of code block and a plurality of values associated with the selected code block type;
retrieving a template corresponding to the selected code block type;
populating the template by executing a code generator on the plurality of values to generate an initial code block;
receiving from a second interface displayed at a second user device associated with a second user, one or more responses associated with the initial code block;
in response to determining that the one or more responses indicate the initial code block is accepted:
generating an executable code block based on the populated template and the one or more responses; and
deploying the executable code block to a blockchain.

12. The system of claim 11, wherein the operations further comprise:
in response to determining that the one or more responses indicate a modification to the initial code block:
transmitting a notification to the first user, the notification containing an indication of the modification of the initial code block;
receiving an acceptance of the modification from the first user; and
generating the executable code block based on the populated template and the modification.

13. The system of claim 11, wherein the operations further comprise:
in response to determining that the one or more responses indicate a modification to the initial code block:
transmitting a notification to the first user, the notification containing an indication of the modification of the initial code block;
receiving a denial of the modification from the first user;
providing instructions to generate a third interface on a third user device associated with a third user, the third interface allowing the third user to provide an arbitration response;
receiving the arbitration response; and
generating the executable code block based on the populated template, the modification, and the arbitration response.

14. The system of claim 11, wherein the operations further comprise:
after deploying the executable code block to the blockchain, update a status of the executable code block to active.

15. The system of claim 11, wherein the operations further comprise:
storing a summary of the deployed executable code block to a non-blockchain database.

16. The system of claim 11, wherein the deployed executable code block includes an escrow agreement between the first user and the second user, and wherein the deployed executable code block is associated with an escrow fund.

17. The system of claim 16, wherein the operations further comprise:
receiving a first resolution input from the first user;
receiving a second resolution input from the second user; and
in response to determining that the first resolution input and the second resolution input indicate a deal completion between the first user and the second user:
transferring the escrow fund to the second user.

18. The system of claim 16, wherein the operations further comprise:
receiving a first resolution input from the first user;
receiving a second resolution input from the second user; and
in response to determining that the first resolution input and the second resolution input indicate a deal non-completion between the first user and the second user:
transferring the escrow fund to the first user.

19. The system of claim 16, wherein the operations further comprise:
receiving a first resolution input from the first user;
receiving a second resolution input from the second user; and
in response to determining that the first resolution input and the second resolution input indicate a disagreement between the first user and the second user:
requesting a third user to provide a third resolution input; and
in response to determining that the third resolution input indicates a deal completion between the first user and the second user:
transferring the escrow fund to the second user.

20. The system of claim 16, wherein the operations further comprise:
receiving a first resolution input from the first user;
receiving a second resolution input from the second user; and
in response to determining that the first resolution input and the second resolution input indicate a disagreement between the first user and the second user:
requesting a third user to provide a third resolution input; and
in response to determining that the third resolution input indicates a deal non-completion between the first user and the second user:
transferring the escrow fund to the first user.
